(19) United States
(12) Patent Application Publication
(10) Pub. No.: US 2022/0223340 A1
(43) Pub. Date: Jul. 14, 2022

(54) Method for Secondary Coating of Magnetic Powder Cores Using Phosphoric Acid and Nano-calcium Carbonate

(71) Applicants: Jiangxi Evertech New Material Co., LTD., Yichun (CN); Jiangxi Evertech Holding Co., LTD, Yichun (CN)

(72) Inventors: Miantuan Zhang, Yichun (CN); Shenghua Mao, Yichun (CN); Junjie Chen, Yichun (CN); Jinbin Pi, Yichun (CN); Yuyuan Wen, Yichun (CN); Xin Jin, Yichun (CN)

(73) Assignees: Jiangxi Evertech New Material Co., LTD., Yichun (CN); Jiangxi Evertech Holding Co., LTD, Yichun (CN)

(21) Appl. No.: 17/619,455

(22) PCT Filed: Apr. 27, 2021
(86) PCT No.: PCT/CN2021/090169

§ 371 Date: Dec. 15, 2021

(30) Foreign Application Priority Data
Sep. 23, 2020 (CN) 202011010548.6

(51) Int. Cl. H01F 41/02; H01F 1/147

(52) U.S. Cl. CPC H01F 41/0246; H01F 1/147

(57) ABSTRACT

Disclosed is a method for secondary coating of a magnetic powder core with phosphoric acid and nano-calcium carbonate. In the disclosure, magnetic powder and a phosphoric acid solution are stirred and mixed to obtain a Fe(H₂PO₄)₂ primary coating layer on a surface of the magnetic powder through reaction, and then nano-calcium carbonate is added, stirred and mixed to obtain a Ca(H₂PO₄)₂ secondary coating layer on the surface of the magnetic powder through reaction.

### CROSS REFERENCE TO RELATED APPLICATION

This application claims the benefit and priority of Chinese Patent Application No. 202011010548.6 filed on Sep. 23, 2020, entitled “method for secondary coating of magnetic powder cores using phosphoric acid and nano-calcium carbonate”, the disclosure of which is incorporated by reference herein in its entirety as part of the present application.

### TECHNICAL FIELD

The present disclosure relates to the technical field of preparation of magnetic powder cores, in particular to a method for secondary coating of a magnetic powder core using phosphoric acid and nano-calcium carbonate.

### BACKGROUND ART

In the conventional coating process of magnetic powder cores:

In the first step, phosphoric acid is generally used as a passivating agent and added to a magnetic powder; iron in the magnetic powder and phosphoric acid are subjected to a reaction according to the following equation: Fe+2H₃PO₄═Fe(H₂PO₄)₂+H₂. The Fe(H₂PO₄)₂ produced by the reaction is coated onto the surface of the metal particles for insulation. However, the process has the following disadvantages: 1. when the phosphoric acid reacts with the magnetic powder, the surface of the magnetic powder reacts first, and after the reaction is conducted for a period time, the surface of the magnetic powder is covered by Fe(H₂PO₄)₂, which makes it impossible to proceed the reaction, resulting in excessive phosphoric acid; 2. the Fe(H₂PO₄)₂ coating layer is relatively thin and uneven, especially affected by the subsequent compression molding and heat treatment, resulting in unstable magnetic properties of the magnetic powder core.

In the second step, organic or inorganic adhesives are added thereto. The organic adhesives have disadvantages of low heat-resistant temperature and existence of aging phenomenon, which would affect the performance stability of the magnetic powder core, and significantly reduce the density of the magnetic powder core, resulting in poor DC bias performance. The inorganic adhesives have disadvantages of poor bonding effects and being difficult to molding, which result in low appearance qualification rates in mass production.

### SUMMARY

In order to solve the problems in the conventional process for magnetic powder cores that the coating layer is relatively thin and uneven, which would result in unstable magnetic properties, the use of organic adhesives would result in unstable performance of magnetic powder cores and poor DC bias performance, and the use of inorganic adhesives would result in poor bonding effects and low appearance qualification rates, the present disclosure provides a method for secondary coating of a magnetic powder core using phosphoric acid and nano-calcium carbonate.

The present disclosure is realized by the following technical solutions:

A method for secondary coating of a magnetic powder core using phosphoric acid and nano-calcium carbonate, comprising the following steps:

S1. mixing phosphoric acid and deionized water uniformly in a ratio to obtain a phosphoric acid solution;

S2. placing a magnetic powder into a coating furnace, starting stirring, adding the phosphoric acid solution to the magnetic powder with a ratio of phosphoric acid to the magnetic powder of 0.5-10 wt %, continuing stirring, and subjecting iron in the magnetic powder and phosphoric acid to a reaction according to the following equation: Fe+2H₃PO₄═Fe(H₂PO₄)₂+H₂, to form a Fe(H₂PO₄)₂ primary coating layer on a surface of magnetic powder particles for insulation;

S3. adding nano-calcium carbonate in an amount of 0.1-2 wt % of the weight of the magnetic powder, continuing stirring, and subjecting the nano-calcium carbonate and phosphoric acid that is not completely reacted in the above step to a reaction according to the following equation: 2H₃PO₄+CaCO₃═Ca(H₂PO₄)₂+CO₂+H₂O to form a Ca(H₂PO₄)₂ secondary coating layer on the surface of the magnetic powder particles for further insulation;

S4. heating the coating furnace to a temperature of 120-130° C., and continuing stirring until the resulting reactant is dry to obtain a pretreated magnetic powder;

S5. adding one or two of zinc stearate and aluminum stearate as a lubricant to the pretreated magnetic powder, and mixing uniformly;

S6. subjecting the uniformly mixed magnetic powder to a compression molding to obtain a compact; and

S7. subjecting the compact to an annealing to obtain a secondary coated magnetic powder core with nano-calcium carbonate.

In the present disclosure, in step S3, the nano-calcium carbonate is excessive, which ensures the complete reaction of phosphoric acid; the Ca(H₂PO₄)₂ produced by the reaction has a strong bonding effect, and could replace the adhesive of the conventional process. Moreover, the unreacted nano-calcium carbonate has a high resistivity and fine particle size, and could be filled in the gap between the magnetic powder particles for further bonding and insulation.

In some embodiments, the ratio of the phosphoric acid to the deionized water in step S1 is in the range of 1:(1-10).

In some embodiments, the nano-calcium carbonate has a particle size of not more than 100 nm.

In some embodiments, the magnetic powder is one or more alloy powders selected from the group consisting of pure Fe, FeSi, FeSiAl, FeSiNi, FeNi, FeNiMo, and FeSiCr, with an average particle size of 10-200 μm.

In some embodiments, in step S5, the lubricant is added in an amount of 0.3-1.0% of the weight of the pretreated magnetic powder.

In some embodiments, the stirring after adding phosphoric acid in step S2 is carried out for 30-40 min, and the stirring after adding nano-calcium carbonate in step S3 is carried out for 30-40 min.

In some embodiments, in step S6, the compression molding is carried out at a pressure of 1500-2300 MPa, and the compact is annular or E-shaped or U-shaped in shape.

In some embodiments, the annealing is performed at a temperature of 600-800° C. for 30-90 min under an atmosphere of nitrogen or hydrogen.

In some embodiments, FeSiAl has a chemical composition of 87.8% of iron, 6.8% of silicon and 5.4% of aluminum.

In some embodiments, FeSi has a chemical composition of 94.5% of iron and 5.5% of silicon;

In some embodiments, FeNi has a chemical composition of 54.5% of iron and 45.5% of nickel.

Compared with the prior art, the present disclosure has the following beneficial effects:

1) The surface of the magnetic powder is double-coated, and the gap between the magnetic powder particles is filled with nano-calcium carbonate with high resistivity, which enables the magnetic powder to have very good insulation.

2) Less insulator is used to achieve the same insulation effect for the magnetic powder (the insulator includes Fe(H₂PO₄)₂ produced by the reaction of Fe with phosphoric acid, Ca(H₂PO₄)₂ produced by the reaction of phosphoric acid with calcium carbonate, and excessive nano-calcium carbonate), resulting in good DC bias performance.

3) The bonding materials used for coating are inorganic materials such as nano-calcium carbonate, and Ca(H₂PO₄)₂ produced in the reaction, which have good bonding performance and high appearance qualification rate, and are easy to form, thereby greatly improving the weather resistance, and greatly reducing the cost.

4) The preparation equipment of the present disclosure is simple, easy to operate, and low in cost, which is particularly suitable for industrialized large-scale production.

### BRIEF DESCRIPTION OF THE DRAWINGS

FIG. 1 is a process flow diagram of the method for secondary coating of magnetic powder cores using phosphoric acid and nano-calcium carbonate according to the present disclosure;

FIG. 2 is a diagram showing a comparison of SEM images of the magnetic powder core according to an example of the present disclosure and the magnetic powder core according to the conventional coating process using phosphoric acid after annealing (in which (a) in FIG. 2 shows the SEM image of the magnetic powder core according to an example of the present disclosure, and (b) in FIG. 2 shows the SEM image of the magnetic powder core prepared by the conventional process).

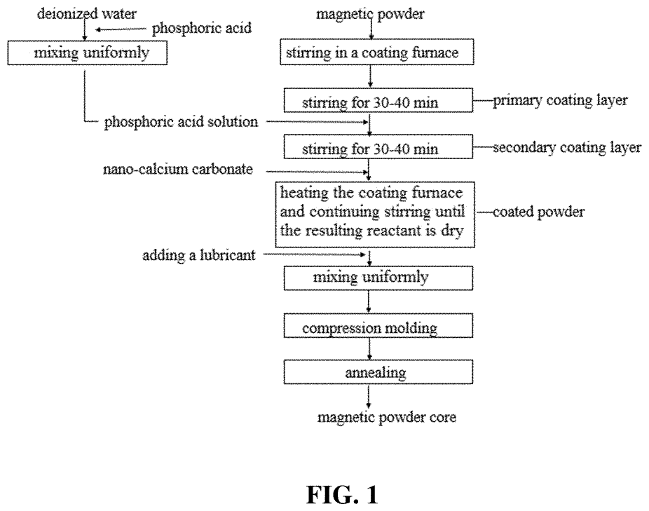

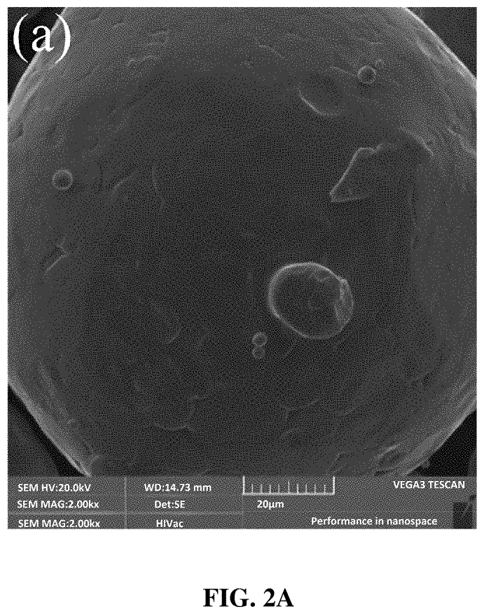

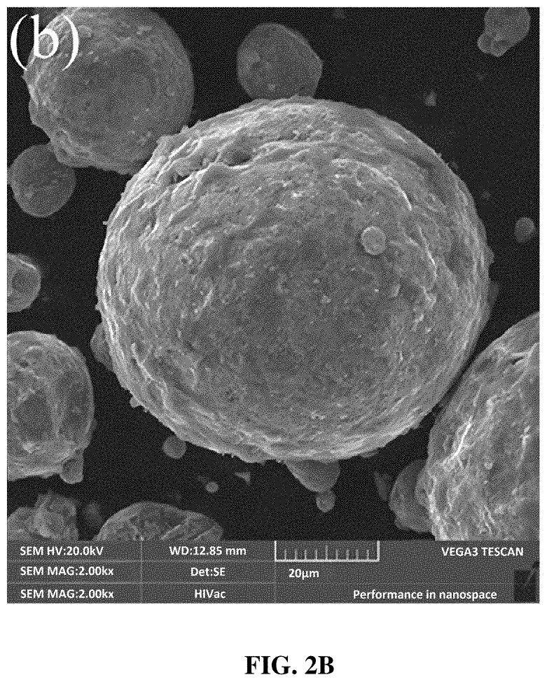

### DETAILED DESCRIPTION OF THE EMBODIMENTS

The present disclosure will be further described below in conjunction with the drawings and specific examples, but the protection scope of the present disclosure is not limited to this:

### Example 1

100 g of phosphoric acid and 100 g of deionized water were taken and mixed uniformly to obtain a phosphoric acid solution for use. 1000 g of FeSiAl (which had a chemical composition of 87.8% of iron, 6.8% of silicon and 5.4% of aluminum) made by the gas atomization process with an average particle size of 38 μm was taken and placed into a coating furnace. Then, the stirring was started. The phosphoric acid solution was added to the coating furnace, and the stirring was continued for another 30 min. 20 g of nano-calcium carbonate with a particle size of less than 100 nm was added thereto, and the stirring was continued for another 30 min. The coating furnace was heated to a temperature of 120° C., and the stirring was continued until the resulting reactant was dry to obtain a pretreated magnetic powder. Zinc stearate was added to the pretreated magnetic powder in an amount of 0.3% of the weight of the pretreated magnetic powder, and they were stirred uniformly. The resulting mixture was subjected to a compression molding to obtain an annular magnetic powder core with an outer diameter of 27.0 mm, an inner diameter of 14.7 mm, and a height of 11.0 mm under a pressure of 2300 MPa. The annular magnetic powder core was kept at 700° C. and under the protection of nitrogen (with a purity of more than or equal to 99.9%) for 30 min, and then subjected to an annealing, obtaining a secondary coated magnetic powder core with phosphoric acid and nano-calcium carbonate.

### Comparative Example 1

An annular magnetic powder core (with an outer diameter of 27.0 mm, an inner diameter of 14.7 mm, and a height of 11.0 mm) was obtained by a conventional coating process for preparing FeSiAl (which had a chemical composition of 87.8% of iron, 6.8% of silicon and 5.4% of aluminum) magnetic powder core by gas atomization using phosphoric acid.

Performance Test

The annular magnetic powder cores obtained in Example 1 and Comparative Example 1 were subjected to a winding test in which a copper wire with φ=0.7 mm was used and wrapped 35 turns. In the test, the inductance test instrument is TH2816B, the loss test instrument is VR152, and the DC bias performance test instrument is CHROMA3302+1320. The results obtained are shown in Table 1.

TABLE 1
Magnetic test results of magnetic powder cores
of Example 1 and Comparative Example 1

| | | | | DC bias performance |
|---|---|---|---|---|
| | | | | (the ratio of magnetic |
| | | | Core | conductivity under |
| | Induc- | Magnetic | losses | 100 Oe DC bias magnet- |
| | tance | conduc- | (50 kHz/ | ic field to initial |
| | (μH) | tivity | 100 mT) | magnetic conductivity) |
| Example | 20.39 | 26.1 | 520 | 78.2% |
| 1 | | | | |
| Comparative | 20.55 | 26.3 | 636 | 76.1% |
| Example | | | | |
| 1 | | | | |

### Example 2

5 g of phosphoric acid and 50 g of deionized water were taken and mixed uniformly to obtain a phosphoric acid solution for use. 1000 g of FeSi (which had a chemical composition of 94.5% of iron, and 5.5% of silicon) with an average particle size of 35 μm was taken and placed into a coating furnace. Then, the stirring was started. The phosphoric acid solution was added to the coating furnace, and the stirring was continued for another 35 min. 1 g of nano-calcium carbonate with a particle size of less than 100 nm was added thereto, and the stirring was continued for another 35 min. The coating furnace was heated to a temperature of 120° C., and the stirring was continued until the resulting reactant was dry to obtain a pretreated magnetic powder. Zinc stearate was added to the pretreated magnetic powder in an amount of 0.4% of the weight of the pretreated magnetic powder, and they were stirred uniformly. The resulting mixture was subjected to a compression molding to obtain an annular magnetic powder core with an outer diameter of 27.0 mm, an inner diameter of 14.7 mm, and a height of 11.0 mm under a pressure of 1500 MPa. The annular magnetic powder core was kept at 720° C. and under the protection of nitrogen (with a purity of more than or equal to 99.9%) for 45 min, and then subjected to an annealing, obtaining a secondary coated magnetic powder core with phosphoric acid and nano-calcium carbonate.

### Comparative Example 2

An annular magnetic powder core (with an outer diameter of 27.0 mm, an inner diameter of 14.7 mm, and a height of 11.0 mm) was obtained by a conventional coating process for preparing FeSi (which had a chemical composition of 94.5% of iron, and 5.5% of silicon) magnetic powder core using phosphoric acid.

Performance Test

The annular magnetic powder cores obtained in Example 2 and Comparative Example 2 were subjected to a winding test, in which a copper with φ=0.7 mm was used and wrapped 35 turns. In the test, the inductance test instrument is TH2816B, the loss test instrument is VR152, and the DC bias performance test instrument is CHROMA3302+1320. The results obtained are shown in Table 2.

TABLE 2
Magnetic test results of magnetic power cores
of Example 2 and Comparative Example 2

| | | | | DC bias performance |
|---|---|---|---|---|
| | | | | (the ratio of magnetic |
| | | | Core | conductivity under |
| | Induc- | Magnetic | losses | 100 Oe DC bias magnet- |
| | tance | conduc- | (50 kHz/ | ic field to initial |
| | (μH) | tivity | 100 mT) | magnetic conductivity) |
| Example | 71.1 | 91 | 589 | 46.3% |
| 2 | | | | |
| Comparative | 71.2 | 91.2 | 696 | 43.2% |
| Example | | | | |
| 2 | | | | |

### Example 3

20 g of phosphoric acid and 100 g of deionized water were taken and mixed uniformly to obtain a phosphoric acid solution for use. 1000 g of FeNi (which had a chemical composition of 54.5% of iron, and 45.5% of nickel) with an average particle size of 30 μm was taken and placed into a coating furnace. Then, the stirring was started. The phosphoric acid solution was added to the coating furnace, and the stirring was continued for another 40 min. 5 g of nano-calcium carbonate with a particle size of less than 100 nm was added thereto, and the stirring was continued for another 40 min. The coating furnace was heated to a temperature of 130° C., and the stirring was continued until the resulting reactant was dry to obtain a pretreated magnetic powder. Zinc stearate was added to the pretreated magnetic powder in an amount of 0.4% of the weight of the pretreated magnetic powder, and they were stirred uniformly. The resulting mixture was subjected to a compression molding to obtain an annular magnetic powder core with an outer diameter of 27.0 mm, an inner diameter of 14.7 mm, and a height of 11.0 mm under a pressure of 2100 MPa. The annular magnetic powder core was kept at 740° C. and under the protection of nitrogen (with a purity of more than or equal to 99.9%) for 60 min, and then subjected to an annealing, obtaining a secondary coated magnetic powder core with phosphoric acid and nano-calcium carbonate.

### Comparative Example 3

An annular magnetic powder core (with an outer diameter of 27.0 mm, an inner diameter of 14.7 mm, and a height of 11.0 mm) was obtained by a conventional coating process for preparing FeNi (which had a chemical composition of 54.5% of iron, and 45.5% of nickel) magnetic powder core using phosphoric acid.

Performance Test

The annular magnetic powder cores obtained in Example 3 and Comparative Example 3 were subjected to a winding test in which a copper wire with φ=0.7 mm was used and wrapped 35 turns. In the test, the inductance test instrument is TH2816B, the loss test instrument is VR152, and the DC bias performance test instrument is CHROMA3302+1320. The results obtained are shown in Table 3.

TABLE 3
Magnetic test results of magnetic powder cores
of Example 3 and Comparative Example 3

| | | | | DC bias performance |
|---|---|---|---|---|
| | | | | (the ratio of magnetic |
| | | | Core | conductivity under |
| | Induc- | Magnetic | losses | 100 Oe DC bias magnet- |
| | tance | conduc- | (50 kHz/ | ic field to initial |
| | (μH) | tivity | 100 mT) | magnetic conductivity) |
| Example | 47.03 | 60.2 | 215 | 77.5% |
| 3 | | | | |
| Comparative | 47.42 | 60.7 | 286 | 75.3% |
| Example | | | | |
| 3 | | | | |

It can be seen from Tables 1, 2, and 3 that compared with the magnetic powder core obtained by conventional coating process, the magnetic powder core obtained in the examples of the present disclosure has greatly reduced core losses, and improved DC bias performance by not less than 2%.

Although the embodiments of the present disclosure have been shown and described, those skilled in the art would understand that various changes, modifications, substitutions, and variations could be made to these embodiments without departing from the principle and spirit of the present disclosure, the scope of the present disclosure is defined by the appended claims and their equivalents.

What is claimed is:

1. A method for secondary coating of a magnetic powder core using phosphoric acid and nano-calcium carbonate, comprising the following steps:
S1. mixing phosphoric acid and deionized water uniformly in a ratio to obtain a phosphoric acid solution;
S2. placing a magnetic powder into a coating furnace, starting stirring, adding the phosphoric acid solution to the magnetic powder with a ratio of phosphoric acid to the magnetic powder of 0.5-10 wt %, continuing stirring, and subjecting iron in the magnetic powder and phosphoric acid to a reaction to form a Fe(H₂PO₄)₂ primary coating layer on a surface of magnetic powder particles;
S3. adding nano-calcium carbonate in an amount of 0.1-2 wt % of the weight of the magnetic powder, continuing stirring, and reacting to form a Ca(H₂PO₄)₂ secondary coating layer on the surface of the magnetic powder particles, the Ca(H₂PO₄)₂ also acting as an adhesive, in which unreacted nano-calcium carbonate is filled in the gap between the magnetic powder particles for further bonding and insulation;
S4. heating the coating furnace to a temperature of 120-130° C., and continuing stirring until the resulting reactant is dry to obtain a pretreated magnetic powder;
S5. adding one or two of zinc stearate and aluminum stearate as a lubricant to the pretreated magnetic powder, and mixing uniformly;
S6. subjecting the uniformly mixed magnetic powder to a compression molding to obtain a compact; and
S7. subjecting the compact to an annealing to obtain a secondary coated magnetic powder core with nano-calcium carbonate.

2. The method for secondary coating of a magnetic powder core using phosphoric acid and nano-calcium carbonate of claim 1, wherein the ratio of the phosphoric acid to the deionized water in step S1 is in the range of 1:(1-10).

3. The method for secondary coating of a magnetic powder core using phosphoric acid and nano-calcium carbonate of claim 1, wherein the nano-calcium carbonate has a particle size of not more than 100 nm.

4. The method for secondary coating of a magnetic powder core using phosphoric acid and nano-calcium carbonate of claim 1, wherein the magnetic powder is one or more alloy powders selected from the group consisting of pure Fe, FeSi, FeSiAl, FeSiNi, FeNi, FeNiMo, and FeSiCr, with an average particle size of 10-200 μm.

5. The method for secondary coating of a magnetic powder core using phosphoric acid and nano-calcium carbonate of claim 1, wherein in step S5, the lubricant added is added in an amount of 0.3-1.0% of the weight of the pretreated magnetic powder.

6. The method for secondary coating of a magnetic powder core using phosphoric acid and nano-calcium carbonate of claim 1, wherein the stirring after adding phosphoric acid in step S2 is carried out for 30-40 min, and the stirring after adding nano-calcium carbonate in step S3 is carried out for 30-40 min.

7. The method for secondary coating of a magnetic powder core using phosphoric acid and nano-calcium carbonate of claim 1, wherein in step S6, the compression molding is carried out at a pressure of 1500-2300 MPa, and the compact is annular or E-shaped or U-shaped in shape.

8. The method for secondary coating of a magnetic powder core using phosphoric acid and nano-calcium carbonate of claim 1, wherein the annealing is performed at a temperature of 600-800° C. for 30-90 min under an atmosphere of nitrogen or hydrogen.

9. The method for secondary coating of a magnetic powder core using phosphoric acid and nano-calcium carbonate of claim 4, wherein FeSiAl has a chemical composition of 87.8% of iron, 6.8% of silicon and 5.4% of aluminum.

10. The method for secondary coating of a magnetic powder core using phosphoric acid and nano-calcium carbonate of claim 4, wherein FeSi has a chemical composition of 94.5% of iron and 5.5% of silicon;
FeNi has a chemical composition of 54.5% of iron and 45.5% of nickel.
